(19) United States
(12) Patent Application Publication
(10) Pub. No.: US 2005/0114626 A1
(43) Pub. Date: May 26, 2005

(54) VERY LONG INSTRUCTION WORD ARCHITECTURE

(76) Inventor: Wen-Long Chin, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,790

(22) Filed: May 28, 2004

(30) Foreign Application Priority Data
Nov. 26, 2003 (TW) 092133217

(51) Int. Cl. G06F 15/00

(52) U.S. Cl. 712/24

(57) ABSTRACT

A very long instruction word (VLIW) architecture has a VLIW input port for sequentially inputting a plurality of VLIWs, a decoder for decoding a plurality of instructions of the VLIWs, at least a register, a plurality of data buses, a plurality of arithmetic logic units (ALUs) for executing the instructions, and a plurality of multiplexers. Each output port of the multiplexers is connected to one of the ALUs, and each input port of the multiplexers is connected to the register and output ports of the ALUs via the data buses. Each of the multiplexers selects two outputs from the outputs of the register and the ALUs so that the connected ALU executes one of the instructions to operate the two selected outputs.

### BACKGROUND OF INVENTION

1. Field of the Invention

The present invention relates to a very long instruction word (VLIW) architecture, and more particularly, to a VLIW architecture in which the outputs of arithmetic logic units (ALUs) can be directly used as the inputs in the next operations.

2. Description of the Prior Art

A modern computer system generally comprises a central processing unit (CPU) for performing operations. With the progress of semiconductor manufacturing, integrated circuits (ICs) are smaller and smaller in area and operate faster and faster. Modern CPUs are also more efficient than the previous CPUs. One of the methods of improving performance of CPUs is by increasing the operating clock. The other is to increase the number of instructions executed within a clock cycle, that is, to let CPUs execute a plurality of instructions in parallel. One of the above-mentioned architecture is named as very long instruction word (VLIW) architecture, combining a plurality of instructions into a VLIW so that a plurality of arithmetic logic units (ALUs) simultaneously execute instructions.

Please refer to FIG. 1. FIG. 1 is a diagram of a VLIW architecture 10 according to the prior art. The VLIW architecture 10 comprises a register file 12, a plurality of ALUs 14, a read-switching array 16, and a write-switching array 18. The register file 12 comprises a plurality of registers for storing data. The data input to the VLIW architecture 10 or the data generated by the VLIW architecture 10 are written into or read from the register file 12. The read-switching array 16 connects to an output port 20 of the register file 12 through a plurality of data-read buses 24. The read-switching array 16 selects the outputs of the register file 12 through the output port 20 according to the instructions of the VLIWs, and sends the outputs to the ALUs 14 for operation. After the ALUs 14 receive the data from the read-switching array 16, the ALUs 14 execute the instructions and store the results into the registers through the write-switching array 18. Shown in FIG. 1, the VLIW 10 further comprises a plurality of data-write buses 26. The write-switching array 18 writes the results into the registers of the register file 12 through the data-write buses 26 and an input port 22 of the register file 12.

Please refer to FIG. 2 and FIG. 3. FIG. 2 is a diagram of a prior art VLIW 30. FIG. 3 is a data structure of an instruction 40 of the VLIW 30 shown in FIG. 2. Each VLIW 30 comprises a plurality of instructions 40, and each instruction 40 can be executed by an ALU 14. Before the VLIW architecture 10 executes a VLIW 30, the VLIW architecture 10 decodes the VLIW 30 into a plurality of instructions 40. Then, the VLIW architecture 10 sends the instructions 40 to the read-switching array 16 and the read-switching array 16 outputs data to the ALUs 14 for operation. Shown as FIG. 3, each instruction 40 is 24 bits in length, including 6 bits of an instruction identification (ID) 42, 6 bits of a first source address 44, 6 bits of a second source address 46, and 6 bits of a destination address 48. The read-switching array 16 reads two units of data from the register file 12 according to the first source address 44 and the second source address 46, and sends the two units of data to one of the ALUs 14. When the ALU 14 receives the two units of data, the ALU 14 operates and generates a result according to the instruction ID 42. Then, the result is stored in the register file 12 through the data-write buses 26 and the input port 22 according to the destination address 48 of the instruction 40.

Please refer to FIG. 4. FIG. 4 is a scheduling chart of the prior art VLIW architecture 10 shown in FIG. 1 executing the VLIW 30. The VLIW architecture 10 executes the VLIW 30 that comprises four instructions 40 by a period t. The eight instructions 40 denoted by I0 to I7 are the valid instructions, while the other instructions denoted by NOP are the instructions of no operation. When the ALUs 14 receive the valid instructions, the ALUs operate according to the instruction ID 42. When the ALUs 14 receive the NOP instructions, the ALUs stand by and do not operate within that period.

Thus, after the ALUs 14 execute an instruction 40 in a period t, the results must be written into the register file 12 through data-write buses 26, which reduces performance of the VLIW architecture 10. For example, when the result generated in a period is used in the next period, the result must be stored in the register file 12 and then read to the ALU 14. The procedure of data access reduces performance of the VLIW architecture 10. In addition, it is clear that all the instructions 40 of each VLIW 30 are not the valid instructions like I0 to I7. Because each instruction 40 occupies 24 bits in length, a lot of storage space is wasted with the NOP instructions.

### SUMMARY OF INVENTION

It is therefore a primary objective of the claimed invention to provide a VLIW architecture to solve the abovementioned problem.

According to the claimed invention, a VLIW architecture comprises a VLIW input port for sequentially inputting a plurality of VLIWs, each VLIW comprising a plurality of instructions, a decoder for decoding the instructions of the VLIWs, at least a register for storing data, a plurality of data buses for transferring data, a plurality of ALUs for executing the instructions of the VLIWs, and a plurality of multiplexers. Each output port of the multiplexers is connected to an input port of one of the corresponding ALUs, and each input port of the multiplexers is connected to the register and output ports of the ALUs via the data buses. Each of the multiplexers selects two outputs from outputs of the register and the ALUs so that the corresponding ALU executes one of the instructions to operate the two selected outputs.

The multiplexers can select data from the register or the ALUS, which efficiently shortens data transferring time. Thus, the present invention VLIW architecture has more efficient performance than the prior art VLIW architecture. In addition, the data structure of the VLIW that differs from that of the prior art in that it reduces memory usage.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a VLIW architecture according to the prior art.

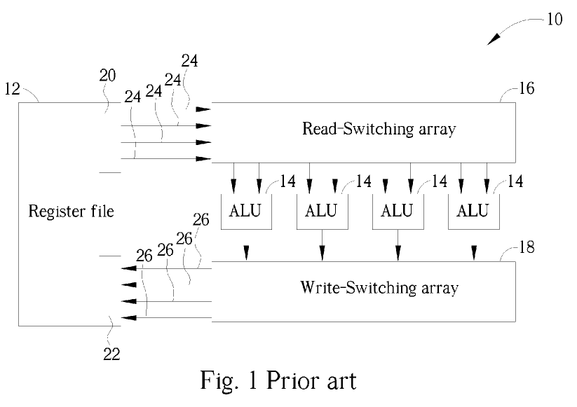

FIG. 2 is a diagram of a prior art VLIW.

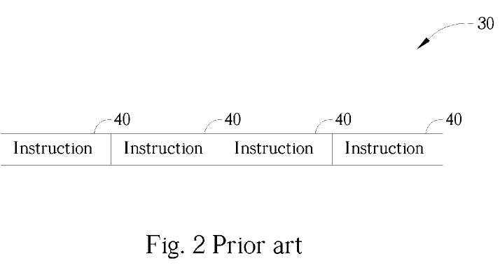

FIG. 3 is a data structure of an instruction of the VLIW shown in FIG. 2.

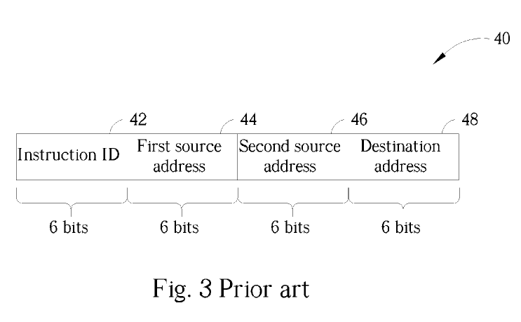

FIG. 4 is a timing chart of the prior art VLIW architecture shown in FIG. 1 executing the VLIW.

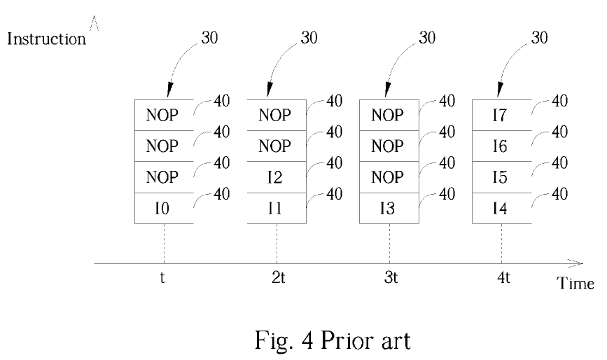

FIG. 5 is a diagram of a VLIW architecture according to the present invention.

FIG. 6 is a diagram of a VLIW used in the VLIW architecture shown in FIG. 5.

FIG. 7 is a data structure of an instruction of the VLIW shown in FIG. 6.

FIG. 8 is a circuit of the VLIW architecture shown in FIG. 5.

FIG. 9 is a diagram of two VLIW shown in FIG. 6.

FIG. 10 is a timing chart of the VLIW architecture shown in FIG. 5 executing the two VLIWs shown in FIG. 9.

### DETAILED DESCRIPTION

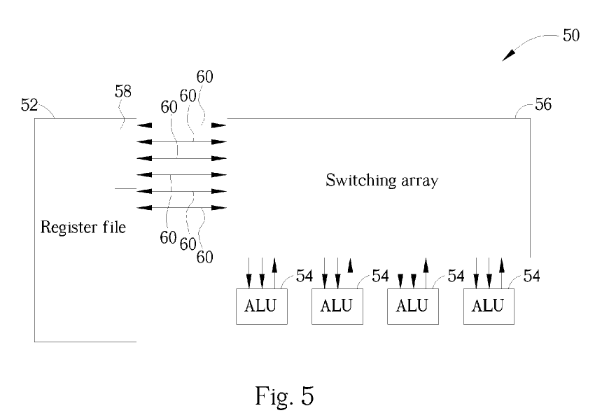

Please refer to FIG. 5. FIG. 5 is a diagram of a VLIW architecture 50 according to the present invention. The VLIW architecture 50 comprises a register file 52, a plurality of ALUs 54, a switching array 56, and a plurality of data buses 60 for transferring data. The register file 52 comprises a plurality of registers for storing data. The data input to the VLIW architecture 50 or the data generated by the VLIW architecture 50 are written into the register file 52 or read to the ALUs 54. The switching array 56 connects to an input/output port 58 of the register file 52 through the data buses 60. The switching array 56 selects the outputs of the register file 52 through the input/output port 58 according to the instructions of the VLIWS, and sends the outputs to the ALUs 54 for operation. After the ALUs 54 receive the data from the read-switching array 56, the ALUs 54 execute instruction to operate the received data and send the results to the switching array 56. Then, the switching array 56 sends the results to other ALU 54 for the next operations or stores the results into the register file 52. Different from the prior art VLIW architecture 10 that must store the results into the register file 12, the VLIW architecture 50 directly sends the results not only to the register file 52 but also to other ALUs 54 for the next operations.

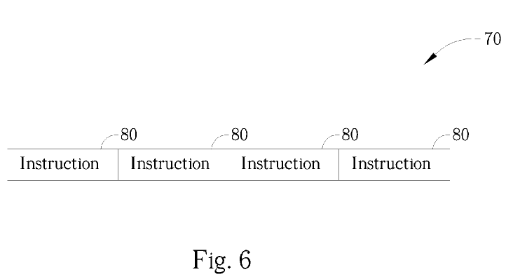

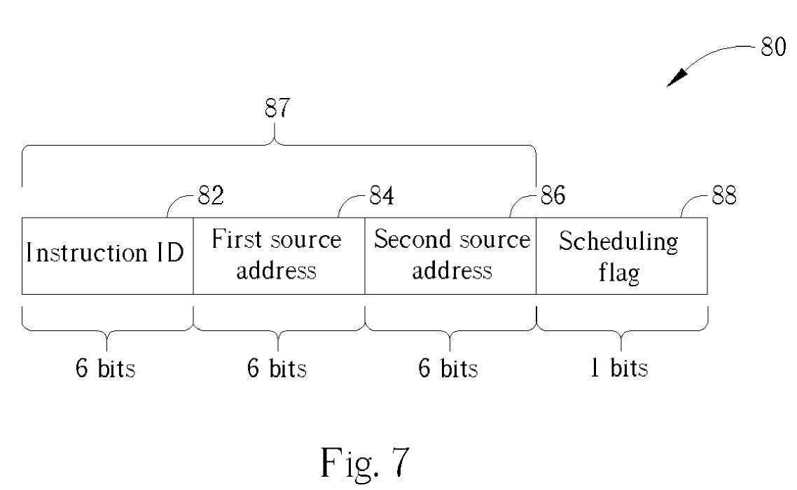

Please refer to FIG. 6 and FIG. 7. FIG. 6 is a diagram of a VLIW 70 used in the VLIW architecture 50 shown in FIG. 5. FIG. 7 is a data structure of an instruction 80 of the VLIW 70 shown in FIG. 6. Similar with the VLIW 30, each VLIW 70 comprises a plurality of instructions 80, and each instruction 80 can be executed by an ALU 54. Before the VLIW architecture 50 executes a VLIW 70, the VLIW architecture 50 decodes the VLIW 70 into a plurality of instructions 80. Then, the VLIW architecture 50 sends the instructions 80 to the switching array 56 and the ALUs 54 so that the switching array 56 outputs data to the ALUs 54 for operation. Different from the data structure of the instructions 40, each instruction 80 is 19 bits in length, including 6 bits of an instruction identification (ID) 82, 6 bits of a first source address 84, 6 bits of a second source address 86, and 1 bit of a scheduling flag 88. The combination of the instruction ID 82, the first source address 84, and the second source address 86 is named as an instruction body 87. The switching array 56 reads the corresponding data from the register file 52 or the ALUs 54 according to the first source address 84 and the second source address 86. For example, if the instruction ID 82 of the instruction 80 indicates addition, the ALU 54 adds the data in the first source address 84 and the second source address 86. If the instruction ID 82 of the instruction 80 indicates movement, the switching array moves the data from the first source address 84 to the second source address 86. In addition, the scheduling flag 88 is used to designate the order of execution. The detail operations of VLIW architecture 50 are described in the following.

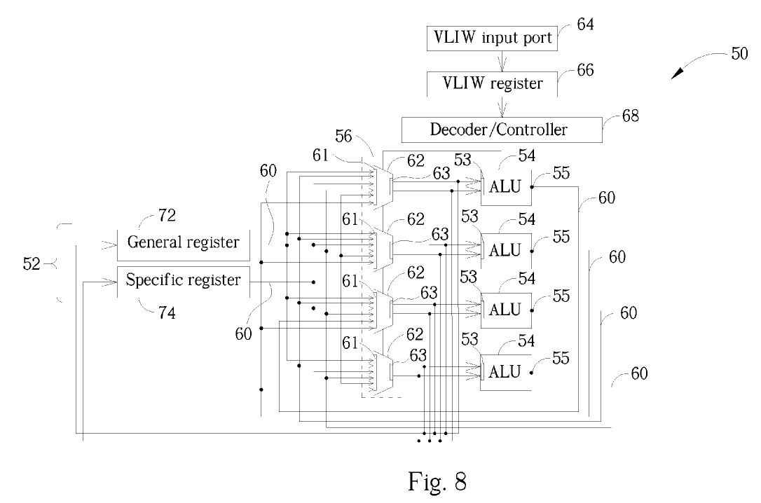

Please refer to FIG. 8. FIG. 8 is a circuit of the VLIW architecture 50 shown in FIG. 5. The VLIW architecture 50 further comprises a VLIW input port 64, a VLIW register 66, and a decoder/controller 68. The register file 52 can be divided into a general register 72 and a specific register 74. Please notice that the register file 52 is simplified in the embodiment, and the number of the registers is not limited to two. The VLIW input port 64 is used for inputting a plurality of VLIW 70. The VLIW register 66 is used for registering the VLIW 70 input by the VLIW input port 64. The decoder/controller 68 is used for decoding the instructions 80 of the VLIWs 70 and controlling the switching array 56 and ALUs 54 so that the multiplexers 62 of the switching array 56 select data to the ALUs 54 according to the instructions 80. The general register 72 is used for storing the data input to the VLIW architecture 50, while the specific register 74 is used according to the related applications. The output port 63 of each multiplexer 62 is connected to the registers 72 and 74 of the register file 52 and an input port 53 of each corresponding ALU 54. The input port 61 of each multiplexer 62 is connected to the register file 52 and the output port 55 of each ALU 54 through the data bus 60. When the VLIW architecture 50 operates, each multiplexer 62 selects two outputs from the registers 72 and 74 of the register file 52 and the outputs of the ALUs 54, and sends the two outputs to the corresponding ALU 54 to operate according to the received instructions 80. Thus, the results operated by the ALUs 54 in a period can be used as the data required by the ALUs 54 in the next period. The results do not need to be stored in the register file 52 and can be directly input to the ALUs 54, which makes the VLIW architecture 50 have better performance than the prior art VLIW architecture.

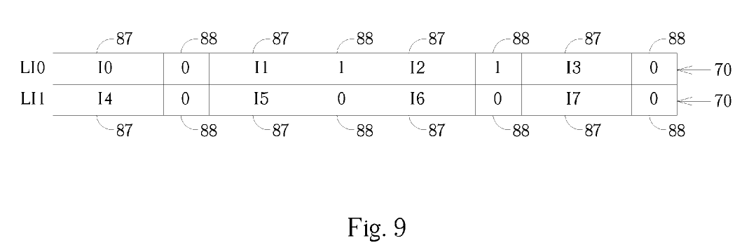

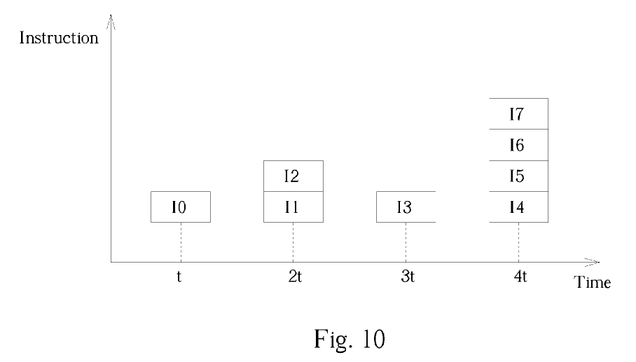

Please refer to FIG. 9 and FIG. 10. FIG. 9 is a diagram of two VLIW 70 shown in FIG. 6. FIG. 10 is a scheduling chart of the VLIW architecture 50 shown in FIG. 5 executing the two VLIWs 70 shown in FIG. 9. Each VLIW 70 comprises a plurality of instructions 80, and each instruction 80 comprises an instruction body 87 and a scheduling flag 88. The scheduling flag 88 is used to decide the order that the ALUs 54 execute the instructions 80, and has one bit in length to store value of 0 or 1. The decoder/controller 68 controls the multiplexers 62 and the ALUs 54 to execute the instructions 80 according to the scheduling flags 88 of the instructions 80. The method in which the decoder/controller operates is such that the instructions 80 are executed in the same period if the flags 88 of the adjacent instructions 80 are the same. That is, if the flags 88 of the adjacent instructions 80 are different, the instructions 80 are executed in different periods. For example, the scheduling flags 88 of the two instructions 80 with the instruction bodies I0 and I1 are different, so the instruction bodies I0 and I1 are executed in different periods t and 2t. The scheduling flags 88 of the two instructions 80 with the instruction bodies I1 and I2 are the same, so the instruction bodies I1 and I2 are executed in the same periods 2t. The instruction bodies I0 to I7 of the VLIW 70 are executed in the order shown in FIG. 10. In contrast to the prior art VLIW 30 that comprises the NOP instruction, the present invention VLIW 70 utilizes the scheduling flag 88 to control the execution order without the NOP instruction. In addition, the 19-bit instruction 80 is shorter than the 24-bit instruction 40, so the VLIW architecture 50 can utilize a memory with less storage space than the VLIW architecture 10. Each multiplexer 62 and the corresponding ALU 54 can be integrated into a component. The embodiment that each ALU 54 further functions as the connecting multiplexer 62 also belongs to the claimed invention.

In contrast to the prior art, the multiplexers of the present invention VLIW architecture can select the registers or the output ports of the ALUs as the data sources. If the ALUs need the results operated in the previous period to operate, the previous results can be directly input to the ALUs rather than stored in the registers. Thus, the present invention VLIW architecture performs better than the prior art. In addition, the data structure of the present invention VLIW utilizes the scheduling flag, so the present invention VLIW architecture can utilize less memory storage space than the prior art VLIW architecture.

Those skilled in the art will readily observe that numerous modifications and alterations of the device may be made while retaining the teachings of the invention. Accordingly, that above disclosure should be construed as limited only by the metes and bounds of the appended claims.

1. A very long instruction word (VLIW) architecture comprising:
a VLIW input port for sequentially inputting a plurality of VLIWs, each VLIW comprising a plurality of instructions;
a decoder for decoding the instructions of the VLIWs;
at least a register for storing data;
a plurality of data buses for sending data;
a plurality of arithmetic logic units (ALUs) for executing the instructions of the VLIWs; and
a plurality of multiplexers, each output port of the multiplexers being connected to an input port of one of the corresponding ALUs, and each input port of the multiplexers being connected to the register and output ports of the ALUs via the data buses;
wherein each of the multiplexers selects two outputs from outputs of the register and the ALUs to send to the corresponding ALU so that the corresponding ALU executes one of the instructions to operate the two selected outputs.

2. The VLIW architecture of claim 1 wherein each multiplexer is connected to the decoder, and the multiplexer selects the two outputs from outputs of the register and the ALUs according to the instructions decoded by the decoder.

3. The VLIW architecture of claim 1 wherein each multiplexer periodically selects the two outputs from outputs of the register and the ALUs, and sends the selected two outputs to the corresponding ALU so that the ALU periodically executes the instructions to operate the two selected outputs.

4. The VLIW architecture of claim 1 wherein each instruction comprises a scheduling flag, and the decoder decides the order that the ALUs execute the instructions according to the scheduling flags of the instructions.

5. The VLIW architecture of claim 1 further comprising a VLIW register connected to the VLIW input port and the decoder for storing the VLIWs input from the VLIW input port.

6. The VLIW architecture of claim 1 wherein the output port of each multiplexer connects to the register, and each multiplexer selects an output of the ALUs to store in the register.

7. A very long instruction word (VLIW) architecture comprising:
a VLIW input port for sequentially inputting a plurality of VLIWs, each VLIW comprising a plurality of instructions;
a decoder for decoding the instructions of the VLIWs;
a register file for storing data, the register file comprising a plurality of registers;
a plurality of data buses for transferring data;
a plurality of arithmetic logic units (ALUs) for executing the instructions of the VLIWs; and
a plurality of multiplexers, each output port of the multiplexers being connected to an input port of one of the corresponding ALUs, and each input port of the multiplexers being connected to the register and output ports of the ALUs via the data buses;
wherein each of the multiplexers selects two outputs from outputs of the register and the ALUs to send to the corresponding ALU so that the corresponding ALU executes one of the instructions to operate the two selected outputs.

8. The VLIW architecture of claim 7 wherein each multiplexer is connected to the decoder, and selects the two outputs from outputs of the register and the ALUs according to the instructions decoded by the decoder.

9. The VLIW architecture of claim 7 wherein each multiplexer periodically selects the two outputs from outputs of the register and the ALUs, and sends the selected two outputs to the corresponding ALU so that the ALU periodically executes the instructions to operate the two selected outputs.

10. The VLIW architecture of claim 7 wherein each instruction comprises a scheduling flag, and the decoder decides the order that the ALUs execute the instructions according to the scheduling flags of the instructions.

11. The VLIW architecture of claim 7 further comprising a VLIW register connected to the VLIW input port and the decoder for storing the VLIWs input from the VLIW input port.

12. The VLIW architecture of claim 7 wherein the output port of each multiplexer connects to the registers, and each multiplexer selects an output of the ALUs to store in one of the registers.
